(19) United States
(12) Patent Application Publication
(10) Pub. No.: US 2006/0098677 A1
(43) Pub. Date: May 11, 2006

(54) System and method for performing receiver-assisted slot allocation in a multihop communication network

(75) Inventor: Sebnem Z. Ozer, Altamonte Springs, FL (US)

Correspondence Address: GARDNER CARTON & DOUGLAS LLP;(MESHNETWORKS/MOTOROLA) ATTN: PATENT DOCKET DEPT., 191 NORTH WACKER DRIVE, SUITE 3700, CHICAGO, IL, 60606-1698, US

(73) Assignee: MeshNetworks, Inc., Maitland, FL (US)

(21) Appl. No.: 10/982,762

(22) Filed: Nov. 8, 2004

(51) Int. Cl. H04Q 7/00; H04J 3/16

(52) U.S. Cl. 370/437; 370/329

(57) ABSTRACT

A system and method for providing efficient allocation of slots in a wireless multi-hopping network including a plurality of nodes, the method comprising: providing communications pertaining to the average packet completion rate (PCR) for reception and transmission slots at one or more intermediate nodes from the one or more intermediate nodes to one or more predecessor nodes, so that the one or more predecessor nodes can employ one slot allocation scheme when a congestive condition exists at the one or more intermediate nodes, and so that the one or more predecessor nodes can employ another slot allocation scheme when no congestive condition exists at the one or more intermediate nodes.

### BACKGROUND OF THE INVENTION

1. Field of the Invention

The present invention relates to Media Access Control (MAC) in multihop wireless networks, and to a system and method for providing efficient allocation of slots in a Time Division Multiple Access (TDMA) scheme in a communication network. More particularly, the system and method utilize an algorithm at one or more intermediate nodes in a communication network to monitor reception and transmission slots, and to use this information to alter slot allocation, in response to persistent quality degradation of packet transmission and, more particularly, in response to bottlenecks in a TDMA scheme.

2. Description of the Related Art

Wireless communication networks, such as mobile wireless telephone networks, have become increasingly prevalent over the past decade. These wireless communications networks are commonly referred to as “cellular networks”, because the network infrastructure is arranged to divide the service area into a plurality of regions called “cells”. A terrestrial cellular network includes a plurality of interconnected base stations, or base nodes, that are distributed geographically at designated locations throughout the service area. Each base node includes one or more transceivers that are capable of transmitting and receiving electromagnetic signals, such as radio frequency (RF) communications signals, to and from mobile user nodes, such as wireless telephones, located within the coverage area. The communications signals include, for example, voice data that has been modulated according to a desired modulation technique and transmitted as data packets. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format, which enables a single transceiver at a first node to communicate simultaneously with several other nodes in its coverage area.

In recent years, a type of mobile communications network known as an “ad-hoc” network has been developed. In this type of network, each mobile node is capable of operating as a base station or router for the other mobile nodes, thus eliminating the need for a fixed infrastructure of base stations.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, and in U.S. patent application Ser. No. 09/815,164 entitled “Prioritized-Routing for an Ad-Hoc, Peer-to-Peer, Mobile Radio Access System”, filed on Mar. 22, 2001, the entire content of each being incorporated herein by reference.

As can be appreciated from the nature of wireless “ad hoc” networks such as those discussed above, the number of available slots for packet transmission and the link quality values associated with these slots change over time. In this regard, the maintenance of balanced traffic flow of packet communications (e.g., data packet communications) among nodes and a lessening or thwarting of traffic congestion and, more particularly, bottlenecks are desirable, in order to maximize efficiency and performance of wireless networks.

Congestion problems in conventional wireless “ad hoc” networks are commonplace. In particular, degradative changes in the packet completion rate (PCR) between nodes typically occur, due to the dynamic nature of mobile multi-hopping networks, topology changes between nodes, and to variations in wireless channel characteristics (e.g., random noise close to the receiver nodes). These fluctuations in PCR rates inevitably cause a “back-up” in packet transmission (or a “bottleneck”) at particular node sites, with increasingly large data queues developing at the particular node over a longer period of time. “Bottlenecks” in wireless “ad hoc” networks are troublesome, because they cause actual losses of particular packets and persistent degradation in the quality of packet transmission, in the form of a lessening of both the speed and efficiency of data transmission in the network.

Several techniques exist for using TDMA schemes. U.S. Pat. No 5,719,868, for example, incorporated herein by reference, describes a method that uses multiple frequencies on a TDMA scheme. The allocation of frequencies and slots is constrained on reuse within two hops of the transmitting node. Each node keeps a table of possible communication frequencies and time slots. A specific time slot is allocated for reservation of slots and frequencies between the transmitter and the receiver. Furthermore, composite bit maps are distributed to report assignments. These reports are used to block the frequencies and slots that may collide with other ongoing communications. It is stated that every node is responsible only for assigning slots and frequencies on which it will transmit and not which it will receive. If a receiver detects conflicts (such as if the intended frequency and slot pair is already allocated), it informs the transmitting node. Otherwise, the transmitter will consider the allocation confirmed if it gets a confirmation from all of its neighbors. The link quality of the allocated frequency and slot pairs are not considered.

U.S. patent application No. 20030185166, incorporated herein by reference, describes a hybrid TDMA scheme (CDMA/FDMA/TDMA) with dynamic slot allocation for multihop wireless networks. The nodes determine geographic reuse of slots based on channel quality extracted from the modem. The system uses a dedicated receiver for listening to configuration channel messages. Each node keeps a utilization map to block the allocations that would cause collisions. The allocation is confirmed by the next hop if no neighbor reports any conflict. The data messages are acknowledged by the receiver. Furthermore, power control is used to maintain the signal quality while achieving energy efficient communications.

In U.S. patent application No. 20030012176, incorporated herein by reference, an adaptive reservation scheme is described for TDMA systems in wireless ad-hoc networks. Initial reservation is also checked prior to data transmission by using minislots in data slots. The level of bandwidth reserved is adapted based on the measured traffic rate. The adjustment scheme considers only the transmission slots. Note that this may cause bottlenecks since the increase in slot allocation at the transmitter does not take into account the next hop forwarding capacity. Furthermore, the changes in link quality are not considered.

In U.S. patent application No. 20040028018, incorporated herein by reference, a TDMA scheme is described for wireless systems. The method mitigates the effect of interference and adapts to variations in communication link demands for data with different priority levels. Therefore the scheduling of slots is changed if the potential interference rises or if the link utilization metrics change. The re(de)allocation is initiated by the sender. The receiver generates a combined ranking of the available time slots by using the transmitter and its own ranking (based on the link quality, data transmitted and queue size). The ranking is done for the link from the transmitter to the receiver. As in other cited references, rescheduling is done without considering the forwarding link status at the receiver.

In a dynamic multihop network, the slot allocation should be dynamic to respond to link quality changes due to mobility, wireless channel characteristics and congestion. The documents cited herein, the slots requests are made by the transmitter by mapping the required number of slots to the traffic requirements. The receiver replies to the request by checking the available slots among the ones requested by the transmitter. After the allocation of these slots, if the receiver has growing traffic in its queue then it requests more slots for forwarding the traffic. Since the resources are limited, the allocation of new slots for transmission is limited to those slots not used by any neighbor. In multihopping TDMA systems, as long as the sourcing node has data, a set of slots is allocated at the intermediate node for this traffic. These slots are deallocated if link failures (i.e. high packet error rate) occur or network topology changes. The lack of adaptation based on the forwarding capacity along the path can cause bottlenecks and can delay the recovery after a traffic path is broken. Synchronous slot allocation over multihops or end-to-end reservation schemes can balance the traffic flow, but the dynamic nature of ad-hoc networks cannot guarantee the availability intermediate nodes along routes for a large time scale.

Accordingly, a need exists for a system or method that is capable of monitoring and responding to quality degradations in packet transmission and, more particularly, to lessen or thwart bottlenecks in the network.

### SUMMARY OF THE INVENTION

The present invention relates to a mobile ad-hoc multihopping network. Due to the dynamic nature of mobile multihopping networks, the number of available slots and the link quality values associated to these slots change over time. Therefore, the slot allocation should be adaptive to keep up with the network dynamics. Since multihop networks lack a central controller with complete network information, the slot allocation scheme should be distributed.

An object of the present invention is to provide a distributed method for slot allocation that takes into account the dynamicity of ad-hoc mobile multihopping networks.

Another object of the present invention is to control the arrival and the service rates of the traffic passing through intermediate nodes for achieving a balanced traffic flow over the multihopping paths.

These objectives are substantially achieved by providing a system and method for dynamic slot allocation in multihop TDMA networks. For this purpose, intermediate nodes keep track of the slot allocations for the forwarding traffic. This information is then used to change the allocation of the slots for the reception and transmission of the forwarded traffic.

The present invention relates to a system and method for providing efficient allocation of slots in a wireless multi-hopping network including a plurality of nodes, the method comprising: providing communications pertaining to the average packet completion rate (PCR) for reception and transmission slots at one or more intermediate nodes from the one or more intermediate nodes to one or more predecessor nodes, so that the one or more predecessor nodes can employ one slot allocation scheme when a congestive condition exists at the one or more intermediate nodes, and so that the one or more predecessor nodes can employ another slot allocation scheme when no congestive condition exists at the one or more intermediate nodes.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a block diagram of an example ad-hoc wireless communications network including a plurality of nodes employing a system and method in accordance with an embodiment of the present invention;

FIG. 2 is a block diagram illustrating an example of a mobile node employed in the network shown in FIG. 1; and

FIG. 3 is a conceptual diagram illustrating a bottleneck point in the ad-hoc wireless network shown in FIG. 1.

### DETAILED DESCRIPTION OF THE PREFERRED EMBODIMENTS

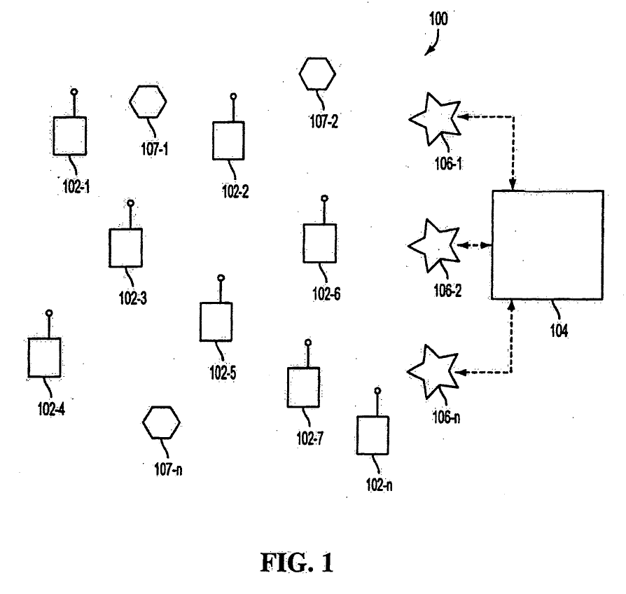

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. Nos. 09/897,790, 09/815,157 and 09/815,164, referenced above.

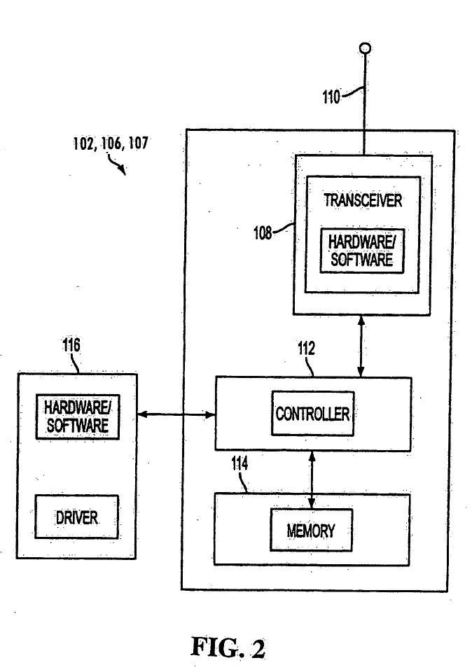

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

As discussed above, it is desirable for the radios or nodes 102, 106 and 107 of the network 100 to be capable of monitoring and responding to persistent quality degradation in packet transmission. As will now be described, an embodiment of the present invention enables the network 100 to monitor and respond to decreases in packet completion rate (PCR) between one or more intermediate nodes and neighboring nodes, in order to provide efficient allocation of slots.

In the embodiment of the present invention described below, a communications system and method is disclosed including an efficient slot allocation scheme for multihop TDMA systems. A distributed and dynamic algorithm is provided at one or more nodes to avoid bottlenecks that may occur due to network dynamics.

Therefore, to have a balanced system, the intermediate node should have a balanced reception (arrival) and transmission (service) rate for forwarded data traffic. In a multihop TDMA system, the arrival rate for an intermediate node is determined by the number of slots during which the node receives traffic to forward and the packet completion rate at these slots. The service time is dependent on the number of slots during which the node transmits this traffic and the packet completion rate at these slots. To avoid bottlenecks at the intermediate nodes, the number and quality of reception slots for forwarding traffic and the number and quality of transmission slots for this traffic should be comparable. The slot allocations over a path can be performed with little delay (without requiring higher layer feedbacks such as routing or application level feedback) and can be dynamically changed if the routes do not meet the QoS requirements. The system can be implemented for flow based traffic management as well as for aggregated packet based traffic management.

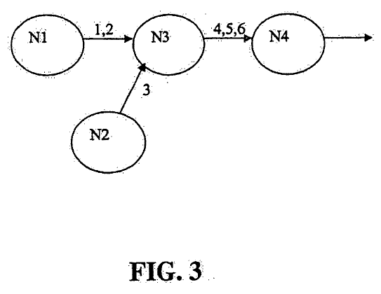

FIG. 3 shows an example network used for illustrating the method of this invention. In this case, all traffic passes through node N3, as indicated by arrows showing the direction of the traffic. The numbers over the arrows indicate the indices of the slots allocated for the corresponding link. It is assumed that the slots are allocated according to any method described in prior art and remain allocated as long as the nodes have traffic. They are deallocated when there is no more traffic or when the slot is not used for a period of time due to the network topology changes.

Table 1 and Table 2 display the packet completion rates (PCR) averaged in the interval [t,t+dt] and [t+dt,t+2dt] for each link respectively. The final destination of data traffic is +N4 which means that N3 forwards all received data.

TABLE 1
Network status between t and t + dt

| Slot number | Link | Final destination | PCR |
|---|---|---|---|
| 1 | N1 −> N3 | No | 0.92 |
| 2 | N1 −> N3 | No | 0.9 |
| 3 | N2 −> N3 | No | 0.9 |
| 4 | N3 −> N4 | — | 0.92 |
| 5 | N3 −> N4 | — | 0.9 |
| 6 | N3 −> N4 | — | 0.95 |

TABLE 2
Network status between t + dt and t + 2dt

| Slot number | Link | Final destination | PCR |
|---|---|---|---|
| 1 | N1 −> N3 | No | 0.9 |
| 2 | N1 −> N3 | No | 0.9 |
| 3 | N2 −> N3 | No | 0.92 |
| 4 | N3 −> N4 | — | 0.6 |
| 5 | N3 −> N4 | — | 0.6 |
| 6 | N3 −> N4 | — | 0.85 |

The changes in the average of PCR's may be caused by the variation of wireless channel characteristics (random noise close to N4) or topology changes. Because of the low PCR rate during the [t+dt, t+2dt] interval, the size of the data queues in N3 at the end of the interval is larger than it was at the beginning of the interval. If the cause of lower PCR during transmitting slots (4, 5 and 6) than in receiving slots (1, 2, and 3), persists for long time, the intermediate node N3 could become the bottleneck of the network and data packets could be lost. For preventing this situation, node N3 should react to the persistent quality degradation of its forwarding link.

The situation can be solved in two ways. In any case, node N3, which have identified the problem, should start the action for correcting the situation:

Node N3 can negotiate with all neighbors the redistribution of time slots. It may be possible that the source of disturbance close to N4 does not operate during slots 1, 2 or 3. For making such decision N3 must have information about PCR with node N4 during these slots.

Node N3 can inform both precursor nodes about the bottleneck condition, asking them to slow down the delivery, if QoS allows such decision.

Node N3 can ask the neighbor to accept swapping the slots between the receiving and transmit sets. In the presented case, slot 2 can be assigned for transmission from N3 to N4. It will slow down the delivery from N1 and increase delivery rate to N4 solving the bottleneck.

The adaptation of slot reservation can be achieved by keeping the following information at each node:

1) The slot number:
The nature of the information depends on the nature of the TDMA system. For pure TDMA systems, the “slot” is the same as the time slot number. For hybrid FDMA/TDMA system the “slot” is the time slot number and the frequency. For a CDMA/TDMA system the “slot” is the time slot and code.

2) The link identifying the transmitter and the receiver node:
Each neighbor of an intermediate node should be either a transmitter or a receiver.

3) Final destination of the traffic:
This is a Boolean entry to distinguish the traffic to be forwarded from the traffic destined for this node. If MAC contends for the packet fields that have the final destination node id, this field can be set by the MAC layer at the receiver. If a higher layer protocol (e.g. routing) checks the final destination, this field may be set from the feedback of the higher layer at the receiver. Another option is to have a field in the MAC header to be set by the transmitter.

4) The moving average of link quality values for both reception and transmission slots
PCR values may be used for this purpose. The moving average can be kept as:
   PCR_{—}ave(t)=(1−λ^{Δt})PCR_{—}cur+λ^{Δt}PCR_{—}ave(t−Δt)
where PCR_cur is the current PCR value, PCR_ave is the average PCR value, Δt is the last time the corresponding PCR was updated and λ is a weight factor.

The PCR values can be computed as the following:
a. If the slot is a transmission slot, the transmitter can compute the PCR values if an ARQ scheme is used. Otherwise, out of band signaling can be used to distribute the number of packets received at the corresponding link for a time interval. The value can be compared to the number of packets transmitted at this time interval.
b. If the slot is a reception slot, the receiver can update the PCR values as long as the transmitter uses the corresponding slot. If there is no data to be transmitted, a NULL data should be sent for this purpose. If the receiver cannot receive the data, it is assumed to be lost. Note that, the transmitter may move out of the range of the receiver. In this case, the PCR values will not be correct until the timeout value to release the slot. However, this will not affect the balancing algorithm. An out of band signaling as described above may also be used for the PCR computation at the receiver.

The intermediate node should keep track of the arrival rate and service rate for the forwarding data. The information about the average link quality should be used to find the cause of the bottleneck. Consequently, the intermediate node should inform the precursor and next hop nodes about condition for negotiating the new allocation of slots.

The intermediate node can keep other statistics (e.g. variance of PCR values) for the adaptation of slot allocation. Furthermore, information that may be used to understand the cause of the bottleneck may be kept (e.g. signal to noise ratio, received power levels etc.).

If the system is flow based, the same mechanism can be applied by checking the final destination of the flows.

The requests from the previous node may not be always satisfied at the first attempt of slot allocations. The information described above along with updated requests can be used to allocate more slots by the receiver node.

As discussed above in the Background section, in the conventional multihop TDMA systems, the requests for slot allocation are initiated by the transmitter. As it can easily be identified, the embodiments of the invention described herein reverses the chain effect, as the (re)deallocation of slots propagates from the affected node towards the source of data, balancing the flow in the network. This balancing algorithm can also be used according to the priority levels of the packets/flows as widely discussed in the prior art.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A method for providing efficient allocation of slots in a wireless multi-hopping network including a plurality of nodes, the method comprising:
providing communications pertaining to the average packet completion rate (PCR) for reception and transmission slots at one or more intermediate nodes from the one or more intermediate nodes to one or more predecessor nodes, so that the one or more predecessor nodes can employ one slot allocation scheme when a congestive condition exists at the one or more intermediate nodes, and so that the one or more predecessor nodes can employ another slot allocation scheme when no congestive condition exists at the one or more intermediate nodes.

2. The method of claim 1, wherein the congestive condition is a decrease in average packet completion rate from the one or more intermediate nodes.

3. The method of claim 1, wherein the congestive condition at the one or more intermediate nodes is a condition wherein there are unbalanced reception and transmission rates for packetized signals.

4. The method of claim 1, wherein the one or more intermediate nodes provide communications to one or more predecessor nodes whereby the one or more intermediate nodes negotiate the redistribution of time slots with the one or more predecessor nodes.

5. The method of claim 1, wherein the one or more intermediate nodes provide communications to one or more predecessor nodes whereby the one or more intermediate nodes inform the one or more predecessor nodes of a congestive condition and request them to decrease packet delivery.

6. The method of claim 1, wherein the one or more intermediate nodes provide communications to one or more predecessor nodes whereby the one or more intermediate nodes request the one or more predecessor nodes to accept swapping slots between receiving and transmitting sets.

7. The method of claim 1, wherein the one or more intermediate nodes store information relating to at least one of the slot number, the link identifying the transmitter and receiver node, the final destination of the traffic, the moving average of link quality values for both reception and transmission slots, and the arrival rate and service rate for forwarding data.

8. A system for providing efficient allocation of slots in a wireless multi-hopping network including a plurality of nodes, the system comprising:
one or more intermediate nodes capable of providing communications pertaining to the average packet completion rate (PCR) for reception and transmission slots at the one or more intermediate nodes to one or more predecessor nodes, so that the one or more predecessor nodes can employ one slot allocation scheme when a congestive condition exists at the one or more intermediate nodes, and so that the one or more predecessor nodes can employ another slot allocation scheme when no congestive condition exists at the one or more intermediate nodes.

9. The system of claim 8, wherein the congestive condition is a decrease in average packet completion rate from the one or more intermediate nodes.

10. The system of claim 8, wherein the congestive condition at the one or more intermediate nodes is a condition wherein there are unbalanced reception and transmission rates for packetized signals.

11. The system of claim 8, wherein the one or more intermediate nodes provide communications to one or more predecessor nodes whereby the one or more intermediate nodes negotiate the redistribution of time slots with the one or more predecessor nodes.

12. The system of claim 8, wherein the one or more intermediate nodes provide communications to one or more predecessor nodes whereby the one or more intermediate nodes inform the one or more predecessor nodes of a congestive condition and request them to decrease packet delivery.

13. The system of claim 8, wherein the one or more intermediate nodes provide communications to one or more predecessor nodes whereby the one or more intermediate nodes request the one or more predecessor nodes to accept swapping slots between receiving and transmitting sets.

14. The system of claim 8, wherein the one or more intermediate nodes store information relating to at least one of the slot number, the link identifying the transmitter and receiver node, the final destination of the traffic, the moving average of link quality values for both reception and transmission slots, and the arrival rate and service rate for forwarding data.
